(19) United States
(12) Patent Application Publication
(10) Pub. No.: US 2016/0162848 A1
(43) Pub. Date: Jun. 9, 2016

(54) SYSTEM AND METHOD OF ENABLING THIRD PARTY ENTITLEMENTS FOR ENTERPRISE PARTNERS BASED ON CUSTOMER PRINTING BEHAVIORS

(71) Applicant: Xerox Corporation, Norwalk, CT (US)

(72) Inventors: Mark James Oliver, Sherwood, OR (US); James Patrick Vanwinkle, West Linn, OR (US); Charles Robert Carlson, Beaverton, OR (US); Connie Margaret Clevenger, Beaverton, OR (US)

(21) Appl. No.: 14/560,076

(22) Filed: Dec. 4, 2014

(51) Int. Cl. G06Q 10/00; G06F 3/12; H04N 1/00; G06Q 30/00

(52) U.S. Cl. CPC G06Q 10/20; G06Q 30/012; G06F 3/1229; G06F 3/1204; G06F 3/1285; H04N 1/00244; H04N 1/00954; H04N 2201/0094

(57) ABSTRACT

A customer workstation with a device discovery tool is connected to a network. The device discovery tool obtains identifying information about document-processing devices connected to the network. The system includes an application server having an account management system operating an entitlement system. A network interface connects the application server with the customer workstation, which stores the identifying information about the document-processing devices. Another network interface connects the application server with a fulfillment provider server external to the entitlement system. The application server determines whether a particular document-processing device needs replacement consumables and provides a recommended order to the customer workstation, identifying each replacement consumable related to an entitlement. The application server coordinates order fulfillment with the fulfillment provider server, based on a unique order identifier. Upon installation of the replacement consumable, the workstation automatically notifies the account management system, which updates the customer account according to the entitlement.

### BACKGROUND

Systems and methods herein are generally related to operation and management of document-processing devices, and more particularly, to methods for enabling third party entitlements for enterprise partners based on customer printing behaviors.

Printers and other document-processing devices (facsimile machines, copiers, multifunction machines, etc.) constantly need replacement of various printing supplies and devices. Often, businesses contract with service agencies that keep the various devices operating properly and provide the necessary supplies to allow the devices to perform their operations. In order to control costs and ensure that various items are utilized as intended by the service agencies, parts are often replaced by the customer (customer replaceable units) and replacement parts are tracked through the use of unique serial number information maintained within the memories of the customer replaceable units.

The conventional office equipment use model has been for the end customer to acquire document-processing devices along with associated consumables, either on a paid-up or leased model. A leased model may include provisions that allow the customer to be billed on a periodic basis for use of the equipment and consumable supplies, with the charges including lease payments for the equipment as well as charges for use of consumables. In order to maintain printers and other document-processing devices operational when needed, businesses, universities, and other organizations must monitor consumable product levels in the devices and ensure that replacement consumables are available when or before installed consumables are depleted, in order to avoid service outages and the expense of rush shipments of replacement products. Conversely, storing replacement consumables at a customer site is costly. In addition, certain device purchase and/or lease programs advantageously offer customers warranty extensions or other incentives for use of so-called program consumables obtained through the supplier or partner and/or for usage in excess of predetermined threshold amounts, and it is desirable to provide systems and methods by which compliance can be verified for such programs. Thus, there is a need for methods and systems to facilitate timely and cost-effective ordering and management of consumable products for document-processing devices associated with a customer account and to enable entitlements for purchase of consumable products from enterprise partners.

Currently, customers that receive service entitlement directly from providers of document-processing devices for purchases made through a consumable product ordering and management platform may obtain such entitlement for an associated device at time of purchase. Purchases made separate from the ordering and management platform may not obtain such entitlement. While large National Partners (NPs) may host their own platforms for customer purchase, payment, and order management, duplicating the equipment provider's system inside the platform of the NPs is not viable. Moreover, NPs may want to offer their full product catalog where the provider of the document-processing devices may only be able support the printer consumable and hardware portion of the catalog. Accordingly, there exists a need for systems and methods for enabling third party entitlements for enterprise partners based on customer printing behaviors.

### SUMMARY

According to an exemplary system herein, a customer workstation is operatively connected to a network. The customer workstation comprises a device discovery tool. Document-processing devices are operatively connected to the network. The device discovery tool automatically obtains identifying information about the document-processing devices connected to the network. The system includes an application server comprising an account management system operating an entitlement system. A first network interface connects the application server with the customer workstation. The application server stores the identifying information about the document-processing devices in a customer account managed by the account management system. A second network interface connects the application server with a fulfillment provider server external to the entitlement system. The application server automatically determines whether a particular document-processing device of the document-processing devices needs a replacement consumable. The application server automatically provides a recommended order for the replacement consumable to the customer workstation. The recommended order has a unique order identifier. The application server automatically identifies each replacement consumable that is related to an entitlement. The application server coordinates order fulfillment between the application server and the fulfillment provider server, based on the unique order identifier. Upon installation of the replacement consumable into the particular document-processing device in which the replacement consumable is related to an entitlement, the customer workstation automatically notifies the account management system of the installation. The application server updates the customer account according to the entitlement.

According to an exemplary method herein, a device discovery tool is provided. The device discovery tool automatically obtains identifying information about document-processing devices connected to a network. Each document-processing device of the document-processing devices is registered to a customer account managed by an account management system operating an entitlement system. Electronic reports are received from the document-processing devices via the network. It is determined whether a particular document-processing device of the document-processing devices needs a replacement consumable based on the electronic reports. A recommended order for the replacement consumable is provided. Each replacement consumable related to an entitlement is identified. Order fulfillment is coordinated between the account management system and a provider of the replacement consumable external to the entitlement system. Notification is received from the particular document-processing device of installation of the replacement consumable. For each replacement consumable installed and related to the entitlement, the customer account is updated according to the entitlement.

According to an exemplary method, a device discovery tool is installed on a customer workstation. The customer workstation is connected to a network. The device discovery tool automatically obtains identifying information about document-processing devices connected to the network. Each document-processing device of the document-processing devices is automatically registered to an account management system connected to the network. Whether a particular document-processing device of the document-processing devices needs a replacement consumable is automatically determined. A recommended order for the replacement consumable is automatically provided to the customer workstation. The recommended order has a unique order identifier. Each replacement consumable being related to an entitlement is automatically identified. Order fulfillment is coordinated between the account management system and a provider of the replacement consumable, based on the unique order identifier. Upon installation of the replacement consumable into the particular document-processing device in which the replacement consumable is related to an entitlement, the account management system is automatically notified of the installation. A customer account managed by the account management system is updated according to the entitlement.

According to a computer system for automatically enabling third party entitlements for enterprise partners based on customer printing behaviors, the computer system comprises a program product comprising a tangible computer readable storage medium having program code embodied therewith. The program code is readable and executable by a computer to provide an application to perform a method. According to the method, a device discovery tool is provided. The device discovery tool automatically obtains identifying information about document-processing devices connected to a network. Each document-processing device of the document-processing devices is registered to a customer account managed by an account management system. Electronic reports are received from the document-processing devices via the network. Whether a particular document-processing device of the document-processing devices needs a replacement consumable is determined based on the electronic reports. A recommended order for the replacement consumable is provided. Each replacement consumable related to an entitlement is identified. Order fulfillment is coordinated between the account management system and a provider of the replacement consumable. Notification is received from the particular document-processing device of installation of the replacement consumable. For each replacement consumable installed and related to the entitlement, the customer account is updated according to the entitlement.

These and other features are described in, or are apparent from, the following detailed description.

### BRIEF DESCRIPTION OF THE DRAWINGS

Various examples of the systems and methods are described in detail below, with reference to the attached drawing figures, which are not necessarily drawn to scale and in which:

FIG. 1 is a block diagram of a network according to systems and methods herein;

FIG. 2 is a system diagram according to systems and methods herein;

FIG. 3 illustrates exemplary customer account information according to systems and methods herein;

FIG. 4 illustrates an exemplary process flow according to systems and methods herein;

FIG. 5 illustrates an exemplary document-processing device according to systems and methods herein;

FIG. 6 is a flow diagram illustrating methods herein;

FIG. 7 is a schematic diagram illustrating devices herein; and

FIG. 8 is a schematic diagram illustrating systems herein.

### DETAILED DESCRIPTION

For a general understanding of the features of the disclosure, reference is made to the drawings. In the drawings, like reference numerals have been used throughout to identify identical elements. While the disclosure will be described hereinafter in connection with specific devices and methods thereof, it will be understood that limiting the disclosure to such specific devices and methods is not intended. On the contrary, it is intended to cover all alternatives, modifications, and equivalents as may be included within the spirit and scope of the disclosure as defined by the appended claims.

In this disclosure, systems and methods are used for tracking customers' behaviors to earn service entitlements. Tools are provided to the customer that can track their behavior in order to meet certain service entitlement requirements. Using the tools, customers can purchase any item from a catalog provided by a third party partner. Those SKUs purchased by the customer that are relevant to meeting service entitlement are flagged by the system. At completion of the customer purchase from the partner, the third party partner transmits purchase data that can be used to monitor a service entitlement. The tools provide additional information about the customers' printer behavior. When the customer meets requirements for entitlement, the entitlement is sent directly to the customer via the tools, without any intervention by the third party partner.

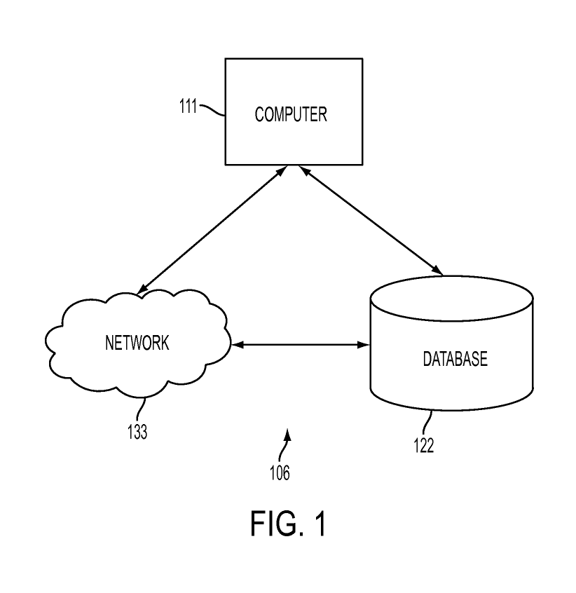

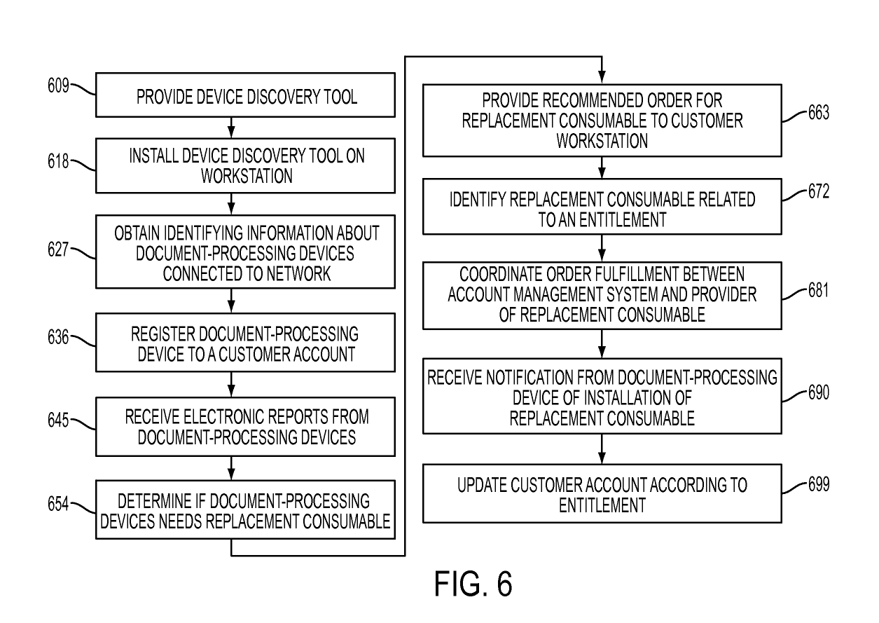

Referring now to the drawings, FIG. 1 is a general overview block diagram of a network, indicated generally as 106, for communication between a computer 111 and a database 122, according to systems and methods herein. The computer 111 may comprise any form of processor as described in further detail below. The computer 111 can be programmed with appropriate application software to implement the methods described herein. Alternatively, the computer 111 is a special purpose machine that is specialized for processing data and includes a dedicated processor that would not operate like a general purpose processor because the dedicated processor has application specific integrated circuits (ASICs) that are specialized for the handling of data processing operations, processing purchasing and replacement data, tracking services, etc. In one example, the computer 111 is a special purpose machine that includes a specialized processing card having unique ASICs for tracking and managing document-processing devices for enabling third party entitlements, includes specialized boards having unique ASICs for input and output devices to speed network communications processing, a specialized ASIC processor that performs the logic of the methods described herein (such as the processing shown in FIG. 6) using dedicated unique hardware, logic circuits, etc.

Database 122 includes any database or any set of records or data that the computer 111 desires to retrieve. Database 122 may be any organized collection of data operating with any type of database management system. The database 122 may contain matrices of datasets comprising multi-relational data elements.

The database 122 may communicate with the computer 111 directly. Alternatively, the database 122 may communicate with the computer 111 over network 133. The network 133 comprises a communication network either internal or external, for affecting communication between the computer 111 and the database 122. For example, network 133 may comprise a local area network (LAN) or a global computer network, such as the Internet.

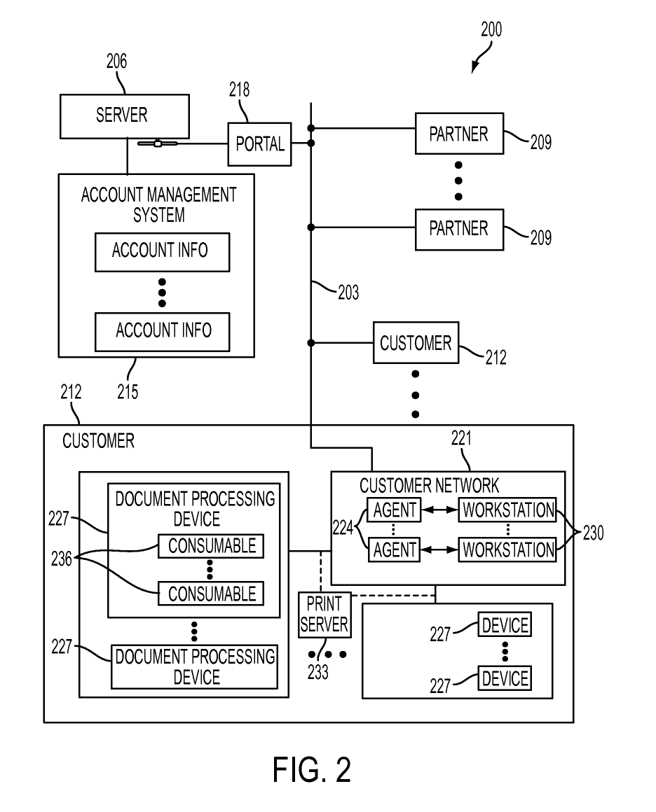

FIG. 2 shows an exemplary networked commercial environment 200, according to systems and methods herein. The networked commercial environment 200 may include one or more networks 203 interconnecting an application server 206 with one or more partners 209 and one or more customers 212. The partners 209 are third party partners separate from the customers 212. As described above, the one or more networks 203 may comprise local area networks (LANs) or a global computer network, such as the Internet. The application server 206 includes an account management system 215, described in further detail below. Access to the account management system 215 implemented in the application server 206 may be accomplished via a portal 218. The application server 206 can include a single computer processor or multiple processing elements, and the application server 206 may be implemented as a single integrated processor-based structure including memory or may be implemented in distributed fashion including multiple structures, some of which are processor-equipped. The account management system 215 can be any suitable combination of processor-based hardware, logic, processor-executed software, firmware, or combinations thereof, and may be implemented in a unitary platform (e.g., application server 206) or in distributed fashion across multiple processor-equipped devices. According to systems and methods herein, the partner(s) 209 and customer(s) 212 may include partner and customer networks, respectively, with computers at the partner(s) 209 and customer(s) 212 being equipped with appropriate software programs that enable authorized, secure, encrypted communication between authorized third party partner resellers and customer personnel and the account management system 215 through access via the portal 218. For example, as shown in FIG. 2, a customer 212 may have a customer network 221 internal to its operations in order to support several customer agents 224. The customer agents 224 provide for operation and management tasks between customer document-processing devices 227 registered to a customer account and the account management system 215 via the portal 218, and also allow the customer 212 to use the customer agent 224 to communicate with one or more document-processing devices 227 coupled to the customer network 221. The customer network 221 may include any form of electronic communication network(s) by which the document-processing devices 227 can communicate directly or indirectly with a customer workstation 230 and/or with the account management system 215, including without limitation dedicated networks, internet connections, and may include connection of one or more document-processing devices 227 with the account management system 215 via networks (wired and/or wireless or combinations thereof). Thus, the network connection of the document-processing devices 227 includes situations in which a primary network connection is inoperative (“network down” condition) with recovery or alternative communications means (e.g., telephone line connection to the document-processing devices 227) being provided as an alternative for communication between the document-processing devices 227 and the account management system 215 for validation or other steps.

One or more print servers 233 may be coupled with the customer network 221, where certain portions of the customer network 221 may be interconnected by cabling or one or more portions may be wireless, and where one or more exemplary customer workstations 230 are in operative communicative coupling to the customer network 221. Any number of customer workstations 230 may be operatively coupled to the customer network 221, including without limitation desktop workstations, laptop workstation, and any number of document-processing devices 227. In the illustrated environment, the customer workstations 230 are selectively authorized to print or initiate other document processing operations via the document-processing devices 227 or predefined subsets of the document-processing devices 227, for example, by appropriate password entry and verification via the customer network 221 and associated network elements and/or by access/usage control features implemented in the document-processing devices 227 themselves. One or more of the document-processing devices 227 may be registered to one or more customer accounts in the account management system 215 and are operable via the customer network 221 or by users actuating on-board controls (e.g., buttons, keypads, etc.) for copying and scanning operations and other tasks. The document-processing devices 227 may include one or more replacement consumables 236, sometimes referred to herein as customer replaceable units or modules (CRUMs), managed by the account management system 215. Replacement consumables 236 include items such as non-print media items or materials consumed by the device during document processing operations, including without limitation toner, ink, a replaceable fuser module/component, replaceable imaging units, waste toner bins, transfer belt, or the like. The customer replaceable units or modules (CRUM) can comprise, for example, photoreceptor units, fusers, drums, rollers, toner cartridges, ink cartridges, etc., and are items that are usually replaced by either a customer or an end user (and do not require the services of a trained service technician). When one or more of the customer replaceable units (e.g. toner cartridges) are replaced, the method described herein causes the document-processing devices 227 to output to the account management system 215 the unique serial numbers of the customer replaceable units that are replaced. The method then analyzes the unique serial numbers using the account management system 215 to determine which specific customer replaceable unit was used within a specific printing device and to provide the appropriate entitlement, as described below.

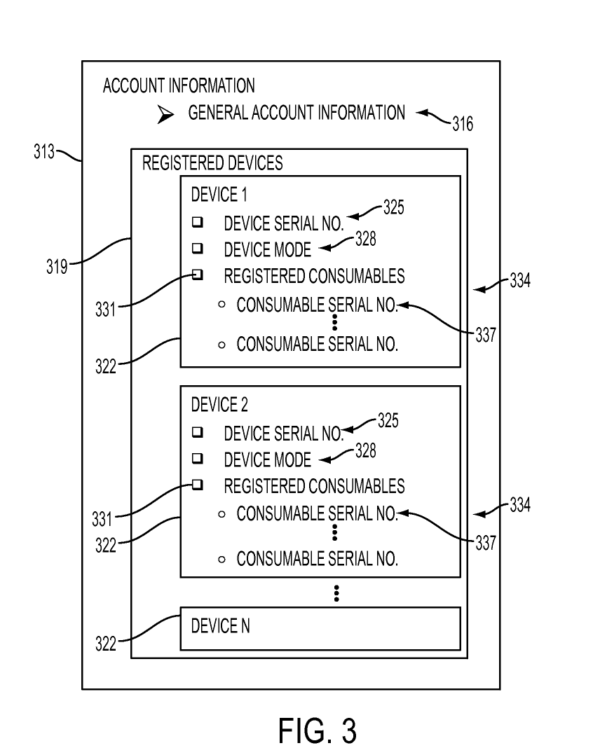

FIG. 3 shows exemplary customer account information according to systems and methods herein. The account management system 215 maintains account information 313 stored in a data store operatively coupled with the application server 206. The data store can be external or internal to the application server 206 or combinations of internal and external storage. The account information 313 may be stored for a plurality of accounts, for example, separate accounts for management of document-processing devices 227 in different departments, and account information may also be stored for multiple different customers, including those customers or ‘vendors’ that register so-called ‘public’ devices. The account information 313 for individual accounts may include general account information 316 (e.g., account owner name, address, billing information, authorized users, etc.), identification information 319 for the registered devices and device information 322 for a plurality of devices individually associated with a particular document-processing device 227 registered by the customer to the account. The device information 322 for individual devices may include a device serial number 325 to identify document-processing devices 227 registered to the account, an indicator of device mode 328 (e.g., including a value indicating toner out, a value indicating whether or not the corresponding document-processing device 227 is managed by the account management system 215, etc.). In addition, the device information 322 includes consumable information 331 about the replacement consumables 236 including consumable identification information 334 for one or more replacement consumables 236 operatively associated with the particular document-processing device 227 with a unique serial number or other identifier 337, in one example. The account information 313 can thus accommodate multiple accounts for multiple customers 212, each associated with multiple document-processing devices 227 of an unlimited number of different device types, where the devices can have one or more identified replacement consumables 236 for management by the account management system 215.

As an example of service entitlement, when a customer 212 purchases and installs the replacement consumable 236 after registering their device in the account management system 215 they earn service entitlement. The entitlement may comprise a warranty on the replacement consumable 236 and the like. The entitlement is determined from device monitoring via the tools in the account management system 215 and data transmitted about their purchases from the partner 209. Other printing behaviors such as page volume, purchase amounts, time in the program, number of registered devices, use of consumables which may disqualify the service entitlement, etc., can be configured in the account management system 215 as alternate requirements for enablement of service offerings.

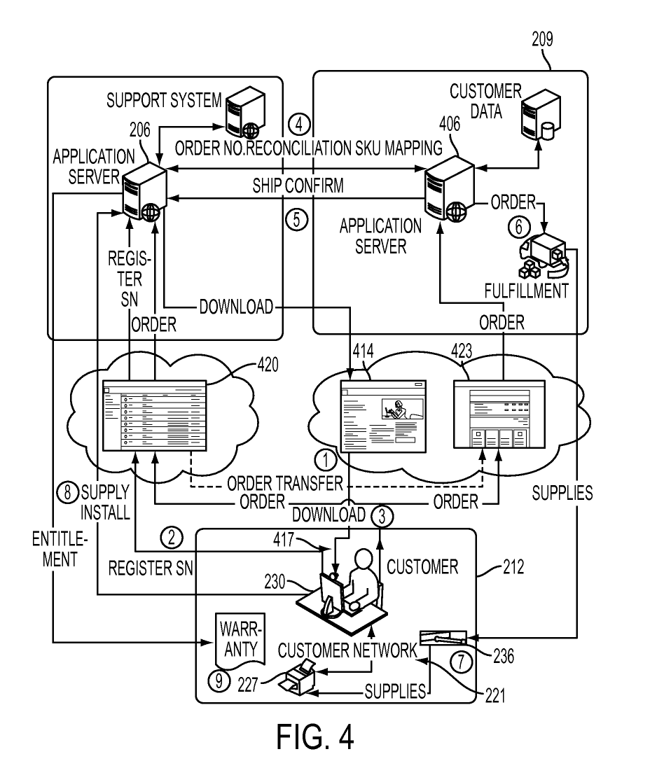

FIG. 4 illustrates an exemplary process flow according to systems and methods herein. As indicated at \textcircled{1}, in order to install the tools for using the system, a customer 212 can go to an appropriate website 414 using a customer workstation 230. If necessary, the customer downloads a device discovery tool 417 from the account management system 215 to automatically send identifying information (serial number, for example) associated with document-processing devices 227 on the customer network 221. Next, as indicated at \textcircled{2}, the customer 212 downloads a client tool 420 (or browser, manual entry, etc.) from the account management system 215 to register the document-processing devices 227 (e.g., providing a serial number) with the account management system 215. That is, the customer 212 registers the serial number using the client tool 420, website. The customer 212 may also learn about program requirements and acknowledge the terms and conditions, if necessary. As indicated at \textcircled{3}, as part of the download from the account management system 215, the customer 212 may be provided a tool for order initiation. The device discovery tool scans the customer network 221 and provides a recommended order, using the client tool 420, for just-in-time fulfillment of needed supplies. The customer 212 can pre-populate the shopping cart, based on perceived needs. According to systems and methods herein, the customer 212 can initiate an order through either the customer application server 206 or the partner application server 406. As indicated at \textcircled{4}, the customer application server 206 and the partner application server 406 reconcile the replacement consumables 236 on order and assign a unique order identifier. According to systems and methods herein, SKUs for replacement consumables 236 have been previously mapped to the system for the partner 209. The unique order identifier is created based on the predetermined SKU list. Alternatively and optionally, the customer 212 may first go to the order site 423 for the partner in order to place orders, as indicated at \textcircled{4}. Once a flagged part is identified in the order process, communication is initiated back to the account management system 215 to map the unique order identifier. As indicated at \textcircled{5}, the partner 209 handles order fulfillment and payment. Once the order is shipped, as indicated at \textcircled{6}, shipment information details are parsed from the order providing information to the account management system 215 on only those SKUs that relate to any entitlements associated with registered document-processing devices 227. Supplies for entitlement are delivered as part of the order from the partner 209 to the customer 212. The customer 212 may receive an order or partial order fulfillment containing SKUs as part of the entitlement or any other item from the catalog of the partner 209. As indicated at \textcircled{7}, the customer 212 receives and installs the replacement consumable(s) 236. The consumable install event is recognized and logged by the document-processing devices 227 and reported to the account management system 215, as indicated at \textcircled{8}. Reporting to the account management system 215 may be accomplished through embedded printer firmware, a desktop client tool, a temporary browser session, etc. Information is reconciled in the account management system 215 against entitlement requirements. Once met, the account management system 215 automatically notifies the customer 212 that they have received their entitlement, as indicated at \textcircled{9}.

In other words, tools are provided to the customer that can track their behavior in order to meet certain service entitlement requirements. Using the tools, customers can purchase any item from a catalog provided by a third party partner. Those SKUs purchased by the customer that are relevant to meeting service entitlement are flagged by the system. At completion of the customer purchase from the partner, the third party partner transmits purchase data that can be used to monitor a service entitlement. The tools provide additional information about the customers' printer behavior. When the customer meets requirements for entitlement, the entitlement is sent directly to the customer via the tools, without any intervention by the third party partner.

Systems and methods herein include a printing device that comprises at least one printing engine (having the customer replaceable units), at least one engine controller operatively connected to the printing engine, at least one computer storage medium operatively connected to the engine controller, and an input/output interface operatively connected to the engine controller. The customer replaceable units (i.e., replacement consumables 236) may comprise a memory unit and each of the memory units within the customer replaceable units stores a unique corresponding serial number for that unit. The serial number is stored within the memory unit at the time of manufacturing the customer replaceable units. The engine controller reads the serial number from the memory unit and stores the serial number within the computer storage medium. An input/output interface provides the serial numbers of the customer replaceable units to the account management system 215 in the application server 206 when one or more of the customer replaceable units needs replacement. The system may store historical information such as a record of service requests, printer diagnostic data, and the suggested solution at the application server 206. Warranty information may also be stored in the application server 206 and the warranty entitlement information may be updated automatically at the time of consumable installation.

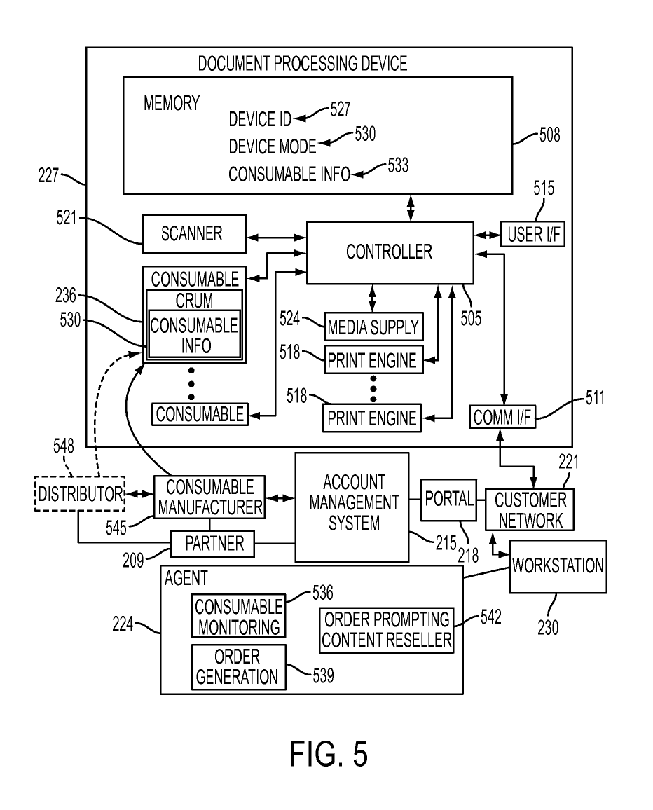

An exemplary document-processing device 227 is shown in FIG. 5 with a processor-equipped controller 505 and a memory 508, where the document-processing device 227 is programmed or provided with suitable processor-executed software, firmware, logic, etc., to controllably provide document processing functions such as printing, faxing, scanning, or combinations thereof and to implement the entitlement features of a device registered to an account managed by the account management system 215. In the illustrated example, a communications interface 511 provides for interfacing the document-processing device 227 with the customer network 221 for communicative exchange of data, information, print jobs, etc., with other networked devices, computers, etc., including customer workstation 230 and customer agents 224 thereof, and with the account management system 215 via the portal 218. The customer workstation 230 can be connected to the account management system 215 through one of the following interfaces: TCP/IP based web server interface; front panel keyboard wedge interface; service interface; direct hardwired connection; etc. The document-processing device 227 may include a user interface 515 that receives inputs from and provides outputs to, a user associated with the customer 212. In addition, the document-processing device 227 may include one or more document-processing components or systems, such as one or more print engines 518, a scanner 521, media supply 524, and replacement consumable(s) 236, and other such devices (e.g., scanners, sheet feeders, etc., not shown). The memory 508 in this example stores program code and processor-executable instructions for implementing the device functionality, as well as local data to support this operation, including device identification (ID) information 527, such as a device serial number, type, etc., the current device mode information 530 (e.g., corresponding to the device mode 328 in the account information 313 in FIG. 3), and consumable information 533 obtained from processing elements of the replacement consumable(s) 236 via the controller 505 (corresponding to consumable information 331 in FIG. 3), and where the customer agent 224 operates when possible to obtain information from the document-processing device 227 (while the document-processing device 227 is connected to the customer network 221), and updates the account information 313 of the account management system 215, accordingly.

It is further noted that the interaction of the account management system 215, the components of the customer agent 224 on the customer workstation 230, and the document-processing devices 227 can be implemented using multiple messages for requests, confirmations, authorizations, data exchanges, value updates, and other tasks, and the messages can be created and transmitted via any suitable network protocols, etc., and where the messaging is preferably controlled by appropriate authorization, password permission control, encryption, and other techniques to prevent uncontrolled print unit creation without authorization by the account management system 215, and to guard against unauthorized access to the account information 313.

Other details of the account management system 215 provide a method for creating consumable orders and/or for verifying usage of consumables from approved partners 209 for one or more document-processing devices 227 registered to an account managed by the account management system 215. The order generation concepts illustrated and described above may be implemented in association with document-processing devices 227 based on replacement consumables 236, as described above. In one exemplary implementation, the customer agent 224 and components thereof may comprise an application program installed to execute on the customer workstation 230 or may be implemented as hardware, processor-executed software, firmware, etc., on any hardware-inclusive platform having at least one processing element operatively coupled with a network (e.g., customer network 221) to communicate with at least one document-processing device 227 via the customer network 221. The customer agent 224 includes a consumable monitoring component 536 operable by the customer workstation 230 to receive electronic reports from one or more document-processing devices 227 via the customer network 221 and to determine whether a particular document-processing device 227 needs or will soon need a replacement consumable 236 based at least partially on the electronic reports. The consumable monitoring component 536 may also receive print consumption information from the electronic reports and update the account management system 215 with device print consumption information, which the account management system 215 can then use to ascertain whether or not the customer is in compliance with minimum usage requirements established for incentive eligibility for a given account.

The customer agent 224 may also include an order generation component 539 operable by the processing element of the customer workstation 230 to selectively prompt a user to place a proposed order for a replacement consumable 236 based on the determination of the consumable monitoring component 536. In the illustrated example, moreover, the order generation component 539 renders order prompting content 542 associated with a particular partner 209 when prompting the user to place a proposed order for a replacement consumable 236, and allows the particular partner 209 to provide and/or modify the order prompting content 542. The order prompting content 542 provides an indication of a particular partner 209, such as logos or other identifiers. In this regard, the customer agent 224 may locally store the order prompting content 542 for more than one different partner 209 for selective rendering to the customer, and the order generation component 539 employs the entire catalog for a particular partner 209 for each proposed order prompting such that the user's ordering process is tailored to the partner 209 with which the customer normally interacts for ordering the particular replacement consumable 236 needed. The order generation component 539 also allows the user to modify the proposed order, for example, to add ordered items, modify proposed order items, change quantities, to select shipping options, and to generally adjust any order parameters normally selectable by the user in placing an order. Once the user has chosen to proceed with a proposed or modified order, the order generation component 539 provides corresponding order information to the account management system 215 via the network 203 for placing an order for a replacement consumable 236. In practice, the account management system 215 can then process the order, in cooperative arrangement with the partner 209, with the replacement consumable(s) 236 being shipped to the customer 212 from a consumable manufacturer 545 or distributor 548 under the direction of the partner 209. As described above, one the replacement consumable 236 has been installed, the document-processing device 227 notifies the account management system 215 and any entitlement is sent direct to the customer without any intervention by the third party partner 209. That is, once the replacement consumable 236 is installed and verified, the CRUM data can be scanned and the serial number (identity) of the received replacement consumable 236 is sent to the account management system 215. The account management system 215 initiates one or more automatic entitlement actions based on the identified source document-processing device 227 and the known consumable identity.

It is contemplated that the document-processing device 227 automatically sends the consumable installation information to the account management system 215 via established network connections (e.g., networks 203, customer network 221, portal 218 in FIG. 2, etc.), and in certain situations, for instance where one or more network connections are inoperative, the installation validation process can be securely accomplished with manual steps. For example, the document-processing devices 227 may render an installation code (e.g., as a code string displayed on the user interface 515, which may be rendered via menu selection, with/without password/authorization entry protection). In this case, the customer/user obtains the installation code from the user interface 515 and provides the installation code by any suitable means to the account management system 215 for validation (e.g., verbally by telephone to an operator at the account manager site or via another acceptable method). The account management system 215 then verifies the installation code (accept/reject) and provides a validation code string for verbal or other conveyance to the customer/user who inputs the validation string into the document-processing device 227 manually via the user interface 515. The document-processing device 227 determines from the entered string whether or not the transaction code was accepted. Thus, even absent a communication link allowing automatic handshake on the installation process, the transaction code generated by the document-processing device 227 can be conveyed by any acceptable means to the account management system 215 and the validation determination is provided to the document-processing device 227 manually.

The disclosed methods and account management systems thus facilitate accounting, provisioning, and controlled usage of a variety of different document-processing devices 227 associated with an account, allowing entitlement for enterprise partners to be sent direct to the customer without any intervention by the third party partner. The architecture, moreover, allows account tracking to be made easily by using unique order identifiers based on a predetermined SKU list. The account management system 215 also facilitates automatic transfer of CRUM data from one device to another as well as from a document-processing device 227 back to a customer account, thereby enhancing a customer's ability to manage printing devices and users. The system also allows consumables, such as toner cartridges, to be transferred from one document-processing device 227 to another, with the receiving unit reading the consumable identifier (e.g., serial number) and updating the account information in the account management system 215, accordingly.

As described above, a system is disclosed that uses a customer workstation 230 that is operatively connected to a network 203, 221. The customer workstation 230 comprises a device discovery tool 417. Document-processing devices 227 are operatively connected to the network 203, 221. The device discovery tool 417 automatically obtains identifying information about the document-processing devices 227 connected to the network 203, 221. The system includes an application server 206 comprising an account management system 215 operating an entitlement system. A first network interface connects the application server 206 with the customer workstation 230. The application server 206 stores the identifying information about the document-processing devices 227 in a customer account managed by the account management system 215. A second network interface connects the application server 206 with a partner application server 406 for the fulfillment provider, which is external to the entitlement system. The application server 206 automatically determines whether a particular document-processing device 227 of the document-processing devices needs a replacement consumable 236. The application server 206 automatically provides a recommended order for the replacement consumable 236 to the customer workstation 230. The recommended order has a unique order identifier. The application server 206 automatically identifies each replacement consumable 236 that is related to an entitlement. The application server 206 coordinates order fulfillment between the application server 206 and the partner application server 406 for the fulfillment provider, based on the unique order identifier. Upon installation of the replacement consumable 236 into the particular document-processing device 227 in which the replacement consumable 236 is related to an entitlement, the customer workstation 230 automatically notifies the account management system 215 of the installation. The application server 206 updates the customer account according to the entitlement.

FIG. 6 is a flow diagram illustrating the processing flow of an exemplary method according to systems and methods herein. The method is useful for automating third party entitlements for enterprise partners based on customer printing behaviors. At 609, a device discovery tool is provided. The device discovery tool is installed on a customer workstation, at 618. The customer workstation is connected to a network. The device discovery tool automatically obtains identifying information about document-processing devices connected to the network, at 627. At 636, each document-processing device of the document-processing devices is registered to a customer account managed by an account management system operating an entitlement system. The account management system is connected to the network. Electronic reports are received from the document-processing devices via the network, at 645. Whether a particular document-processing device of the document-processing devices needs a replacement consumable is automatically determined, at 654, based on the electronic reports. A recommended order for the replacement consumable is automatically provided to the customer workstation, at 663. The recommended order has a unique order identifier. At 672, each replacement consumable being related to an entitlement is automatically identified. Order fulfillment is coordinated between the account management system and a provider of the replacement consumable, at 681, based on the unique order identifier. The provider of the replacement consumable is external to the entitlement system. At 690, upon installation of the replacement consumable into the particular document-processing device, notification is received from the particular document-processing device of the installation of the replacement consumable in which the replacement consumable is related to an entitlement. For each replacement consumable installed and related to the entitlement, the customer account managed by the account management system is updated according to the entitlement, at 699.

Aspects of the present disclosure are described herein with reference to flowchart illustrations and/or block diagrams of methods, apparatus (systems), and computer program products according to various systems and methods. It will be understood that each block of the flowchart illustrations and/or two-dimensional block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

According to a further system and method herein, an article of manufacture is provided that includes a tangible computer readable medium having computer readable instructions embodied therein for performing the steps of the computer implemented methods, including, but not limited to, the method illustrated in FIG. 6. Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. Any of these devices may have computer readable instructions for carrying out the steps of the methods described above with reference to FIG. 6.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

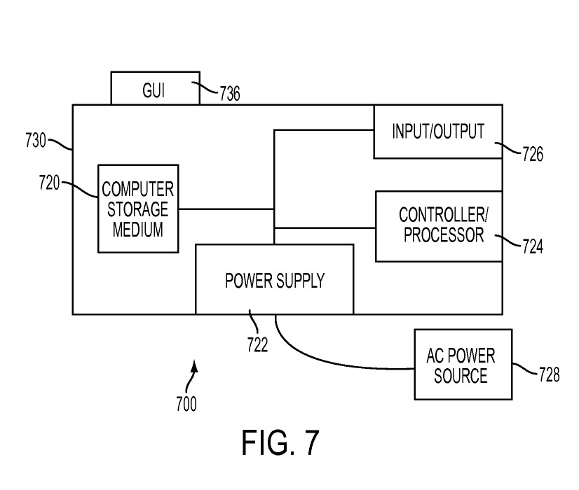

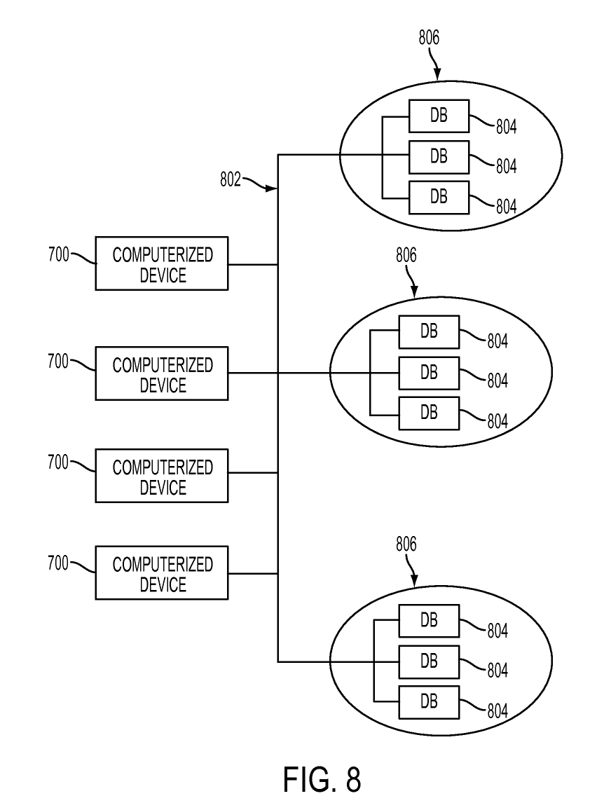

FIG. 7 illustrates a computerized device 700, which can be used with systems and methods herein and can comprise, for example, a personal computer, a portable computing device, etc. The computerized device 700 includes a controller/processor 724 and a communications port (input/output device 726) operatively connected to the controller/processor 724. As described above, the controller/processor 724 may also be connected and to a computerized network 802 external to the computerized device 700, such as shown in FIG. 8. In addition, the computerized device 700 can include at least one accessory functional component, such as a graphic user interface assembly (GUI) 736 that also operates on the power supplied from the external power source 728 (through the power supply 722).

The input/output device 726 is used for communications to and from the computerized device 700. The controller/processor 724 controls the various actions of the computerized device. A non-transitory computer storage medium 720 (which can be optical, magnetic, capacitor based, etc.) is readable by the controller/processor 724 and stores instructions that the controller/processor 724 executes to allow the computerized device 700 to perform its various functions, such as those described herein. Thus, as shown in FIG. 7, a body housing 730 has one or more functional components that operate on power supplied from the external power source 728, which may comprise an alternating current (AC) power source, to the power supply 722. The power supply 722 can comprise a power storage element (e.g., a battery) and connects to an external power source 728. The power supply 722 converts the external power into the type of power needed by the various components.

In case of implementing the systems and methods herein by software and/or firmware, a program constituting the software may be installed into a computer with dedicated hardware, from a storage medium or a network, and the computer is capable of performing various functions if with various programs installed therein.

In the case where the above-described series of processing is implemented with software, the program that constitutes the software may be installed from a network such as the Internet or a storage medium such as the removable medium.

Those skilled in the art would appreciate that the storage medium is not limited to a peripheral device having the program stored therein, which is distributed separately from the device for providing the program to the user. Examples of a removable medium include a magnetic disk (including a floppy disk), an optical disk (including a Compact Disk-Read Only Memory (CD-ROM) and a Digital Versatile Disk (DVD)), a magneto-optical disk (including a Mini-Disk (MD) (registered trademark)), and a semiconductor memory. Alternatively, the computer storage medium 720 may be a hard disk, or the like, which has the program stored therein and is distributed to the user together with the device that contains them.

As will be appreciated by one skilled in the art, aspects of the devices and methods herein may be embodied as a system, method, or computer program product. Accordingly, aspects of the present disclosure may take the form of an entirely hardware system, an entirely software system (including firmware, resident software, micro-code, etc.) or an system combining software and hardware aspects that may all generally be referred to herein as a ‘circuit’, ‘module, or ‘system.’ Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a Read Only Memory (ROM), an Erasable Programmable Read Only Memory (EPROM or Flash memory), an optical fiber, a magnetic storage device, a portable compact disc Read Only Memory (CD-ROM), an optical storage device, a “plug-and-play” memory device, like a USB flash drive, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods, and computer program products according to various devices and methods herein. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As shown in FIG. 8, exemplary systems and methods herein may include various computerized devices 700 and databases 804 located at various different physical locations 806. The computerized devices 700 and databases 804 are in communication (operatively connected to one another) by way of a local or wide area (wired or wireless) computerized network 802.

Many computerized devices are discussed above. Computerized devices that include chip-based central processing units (CPU's), input/output devices (including graphic user interfaces (GUI), memories, comparators, processors, etc., are well-known and readily available devices produced by manufacturers such as Dell Computers, Round Rock Tex., USA and Apple Computer Co., Cupertino, Calif., USA. Such computerized devices commonly include input/output devices, power supplies, processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terminology used herein is for the purpose of describing particular examples of the disclosed structures and methods and is not intended to be limiting of this disclosure. For example, as used herein, the singular forms ‘a’, ‘an’, and ‘the’ are intended to include the plural forms as well, unless the context clearly indicates otherwise. Additionally, as used herein, the terms ‘comprises’, ‘comprising’, and/or ‘including’, when used in this specification, specify the presence of stated features, integers, steps, operations, elements, and/or components, but do not preclude the presence or addition of one or more other features, integers, steps, operations, elements, components, and/or groups thereof. Further, the terms ‘automated’ or ‘automatically’ mean that once a process is started (by a machine or a user), one or more machines perform the process without further input from any user.

The corresponding structures, materials, acts, and equivalents of all means or step plus function elements in the claims below are intended to include any structure, material, or act for performing the function in combination with other claimed elements as specifically claimed. The descriptions of the various devices and methods of the present disclosure have been presented for purposes of illustration, but are not intended to be exhaustive or limited to the devices and methods disclosed. Many modifications and variations will be apparent to those of ordinary skill in the art without departing from the scope and spirit of the described devices and methods. The terminology used herein was chosen to best explain the principles of the devices and methods, the practical application or technical improvement over technologies found in the marketplace, or to enable others of ordinary skill in the art to understand the devices and methods disclosed herein.

It will be appreciated that the above-disclosed and other features and functions, or alternatives thereof, may be desirably combined into many other different systems or applications. Those skilled in the art may subsequently make various presently unforeseen or unanticipated alternatives, modifications, variations, or improvements therein, which are also intended to be encompassed by the following claims. Unless specifically defined in a specific claim itself, steps or components of the systems and methods herein should not be implied or imported from any above example as limitations to any particular order, number, position, size, shape, angle, color, temperature, or material.

What is claimed is:

1. A system, comprising:
a customer workstation operatively connected to a network, said customer workstation comprising a device discovery tool;
document-processing devices operatively connected to said network, said device discovery tool automatically obtaining identifying information about said document-processing devices connected to said network;
an application server comprising an account management system operating an entitlement system;
a first network interface connecting said application server with said customer workstation, said application server storing said identifying information about said document-processing devices in a customer account managed by said account management system; and
a second network interface connecting said application server with a fulfillment provider server external to said entitlement system,
said application server automatically determining a particular document-processing device of said document-processing devices in need of a replacement consumable,
said application server automatically providing a recommended order for said replacement consumable to said customer workstation, said recommended order having a unique order identifier,
said application server automatically identifying each said replacement consumable being related to an entitlement,
said application server coordinating order fulfillment between said application server and said fulfillment provider server, based on said unique order identifier,
upon installation of said replacement consumable into said particular document-processing device, said replacement consumable being related to an entitlement, said customer workstation automatically notifying said account management system of said installation; and
said application server updating said customer account according to said entitlement.

2. The system according to claim 1, said replacement consumable further comprising a customer replaceable unit comprising a memory unit.

3. The system according to claim 1, said replacement consumable comprising:
toner cartridges, photoreceptor units, drums, rollers, and fusers.

4. The system according to claim 1, said document-processing devices being connected to said application server through one of the following interfaces:
TCP/IP based web server interface;
front panel keyboard wedge interface;
service interface;
print job submission interface; and
direct hardwired connection.

5. The system according to claim 1, said identifying information about said document-processing devices connected to said network comprising unique serial numbers.

6. The system according to claim 1, further comprising: a data store implemented in said application server storing order prompting content associated with a plurality of partners.

7. The system according to claim 1, said entitlement comprising warranties on said replacement consumable.

8. A method, comprising:
providing a device discovery tool, said device discovery tool automatically obtaining identifying information about document-processing devices connected to a network;
registering each document-processing device of said document-processing devices to a customer account managed by an account management system operating an entitlement system;
receiving electronic reports from said document-processing devices via said network;
determining a particular document-processing device of said document-processing devices in need of a replacement consumable based on said electronic reports;
providing a recommended order for said replacement consumable;
identifying each said replacement consumable being related to an entitlement;
coordinating order fulfillment between said account management system and a provider of said replacement consumable external to said entitlement system;
receiving notification from said particular document-processing device of installation of said replacement consumable; and
for each said replacement consumable installed and being related to said entitlement, updating said customer account according to said entitlement.

9. The method according to claim 8, said replacement consumable further comprising a customer replaceable unit comprising a memory unit.

10. The method according to claim 8, said replacement consumable comprising:
toner cartridges, photoreceptor units, drums, rollers, and fusers.

11. The method according to claim 8, said document-processing devices being connected to an application server housing said account management system through one of the following interfaces:
TCP/IP based web server interface;
front panel keyboard wedge interface;
service interface;
print job submission interface; and
direct hardwired connection.

12. The method according to claim 8, said identifying information about said document-processing devices connected to said network comprising unique serial numbers.

13. The method according to claim 8, said entitlement comprising warranties on said replacement consumable.

14. A method, comprising:
installing a device discovery tool on a customer workstation, said customer workstation being connected to a network, said device discovery tool automatically obtaining identifying information about document-processing devices connected to said network;
automatically registering each document-processing device of said document-processing devices to an account management system connected to said network;
automatically determining a particular document-processing device of said document-processing devices in need of a replacement consumable;
automatically providing a recommended order for said replacement consumable to said customer workstation, said recommended order having a unique order identifier;
automatically identifying each said replacement consumable being related to an entitlement;
coordinating order fulfillment between said account management system and a provider of said replacement consumable, based on said unique order identifier;
upon installation of said replacement consumable into said particular document-processing device, said replacement consumable being related to an entitlement, automatically notifying said account management system of said installation; and
updating a customer account managed by said account management system according to said entitlement.

15. The method according to claim 14, said replacement consumable further comprising a customer replaceable unit comprising a memory unit.

16. The method according to claim 14, said replacement consumable comprising:
toner cartridges, photoreceptor units, drums, rollers, and fusers.

17. The method according to claim 14, said identifying information about said document-processing devices connected to said network comprising unique serial numbers.

18. The method according to claim 14, said identifying information about said document-processing devices connected to said network comprising unique serial numbers.

19. The method according to claim 14, further comprising: a data store implemented in an application server housing said account management system storing order prompting content associated with a plurality of partners.

20. The method according to claim 14, said entitlement comprising warranties on said replacement consumable.
